(19) United States
(12) Patent Application Publication
(10) Pub. No.: US 2004/0168156 A1
(43) Pub. Date: Aug. 26, 2004

(54) Dynamic instrumentation of related programming functions

(76) Inventors: Robert Hundt, Santa Clara, CA (US); David J. Babcock, San Jose, CA (US); Eric Gouriou, Sunnyvale, CA (US); Sujoy Saraswati, Bangalore (IN); Curt Wohlgemuth, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/349,799

(22) Filed: Jan. 22, 2003

(51) Int. Cl. G06F 9/44

(52) U.S. Cl. 717/130; 717/126

(57) ABSTRACT

A pair of functions setjmp( ) and longjmp( ) shares the data related to the program context. When instrumentation starts, the instrumentation tool creates the instrumented code, resulting in two sets of program code, e.g., the original code and the instrumented code. Functions setjmp( ) and longjmp( ) in the instrumented code may be referred to as functions setjmp′( ) and longjmp′( ), respectively. In one embodiment, when function setjmp′( ) is reached, but before being executed, the setjmp′-continued location is identified, and based on this setjmp′-continued location, the corresponding setjmp-continued location is also identified and saved for later use. When un-instrumentation occurs, the instrumented code is discarded, execution reverts to the original code, and function longjmp( ) is executed, which, based on the saved information, causes execution to continue at the setjmp-continued location. In an alternative embodiment, a breakpoint is set at the setjmp-continued location inside the setjmp block of instructions, and execution reaches this setjmp-continued location regardless of whether function longjmp( ) or function longjmp′( ) is executed. If instrumentation occurs without un-instrumentation, then the breakpoint still exists at this setjmp-continued location. Consequently, when function longjmp′( ) is executed, the setjmp-continued location is reached, the breakpoint is encountered, and execution is directed by the controlling instrumentation tool to continue with the setjmp′ block of instructions. However, if un-instrumentation occurs, then the un-instrumentation process clears the breakpoint. When function longjmp( ) is executed, execution reaches this setjmp-continued location without encountering the breakpoint, and thus continues with the setjmp block of instructions. In another alternative embodiment, the function that includes a call to function setjmp is not instrumented. Consequently, there is only one continued location for function setjmp( ), which is in the original code. Regardless of whether function longjmp( ) or function longjmp′( ) is executed, execution reaches this setjmp-continued location and executes the corresponding setjmp block of instructions.

### FIELD OF THE INVENTION

The present invention relates generally to dynamic instrumentation and, more specifically, to dynamic instrumentation of related functions.

### BACKGROUND OF THE INVENTION

Programming functions may be interdependent, e.g., operations of one function depend on operations of another function. In the C language, a pair of functions setjump( ) and longjmp( ), normally used to deal with errors and interrupts, is an example of interdependence. Function setjmp( ) saves its program context in a buffer, e.g., buffer “buf,” for function longjmp( ) to later use the data in buffer “buf” to restore the environment saved by the last call of function setjmp( ). After function longjmp( ) is executed, program execution continues at the location immediately after the call to function setjmp( ) as if the corresponding call of function setjmp( ) had been executed.

Dynamic instrumentation is used in various software engineering domains such as performance analysis, program optimization, quality assurance, etc. Dynamic instrumentation tools generally add probe code to the original code to form instrumented code and execute this instrumented code. Some examples of probe code operations include adding values to a register, moving the content of one register to another register, moving the address of some data to some registers, inserting a counter at a function entry point to count the number of function invocations, etc. Consequently, during instrumentation, there are two sets of program code, e.g., a set of the original code and a set of the instrumented code.

Un-instrumentation refers to discarding the instrumented code and reverting to execution of the original code. Various problems exist such as when un-instrumentation has occurred but the data associated with the instrumented code, instead of the original code, continues to be used. Similarly, in many situations, the data for the original code is used while the program is being instrumented. Using incorrect data generally results in undesired program behavior.

Based on the foregoing, it is desirable that mechanisms be provided to solve the above deficiencies and related problems.

### SUMMARY OF THE INVENTION

The present invention, in various embodiments, provides techniques for related programming functions to work effectively with dynamic instrumentation. In one embodiment, function setjmp( ) and function longjmp( ) used in a program share the data related to the program context, and constitute a pair of related functions. In accordance with operation of functions setjmp( ) and longjmp( ), once function longjmp( ) is executed, program execution continues at an instruction following the call to function setjmp( ). The location of this instruction may be referred to as the “setjmp-continued” location. When instrumentation starts, the instrumentation tool creates the instrumented code, resulting in two sets of program code, e.g., the original code and the instrumented code. Functions setjmp( ) and longjmp( ) in the instrumented code may be referred to as functions setjmp′( ) and longjmp′( ), respectively.

In one embodiment, when the function setjmp′( ) is reached, but before being executed, the setjmp′-continued location associated with function setjmp′( ) is identified, and based on this setjmp′-continued location, the corresponding setjmp-continued location associated with function setjmp( ) is also identified and saved for later use. When un-instrumentation occurs, the instrumented code of the program is discarded, execution reverts to the original code, and function longjmp( ) in the original code is executed, which, based on the saved information, causes execution to continue at the setjmp-continued location associated with function setjmp( ) in the original code.

In an alternative embodiment, a breakpoint is set at the setjmp-continued location inside the block of instructions associated with function setjmp( ) in the original code, and execution is directed to this setjmp-continued location regardless of whether function longjmp( ) or function longjmp′( ) is executed. If instrumentation occurs without un-instrumentation, then the breakpoint still exists at this setjmp-continued location. Consequently, when function longjmp′( ) is executed, the setjmp-continued location is reached, the breakpoint is encountered, and execution is automatically directed to continue with the block of instructions associated with function setjmp′( ) in the instrumented code. However, if un-instrumentation occurs after instrumentation, then the un-instrumentation process clears the breakpoint at the setjmp-continued location in the original code. When function longjmp( ) is executed, execution reaches this setjmp-continued location without encountering the breakpoint, and thus continues with the block of instructions associated with function setjmp( ) in the original code.

In another alternative embodiment, the function that includes a call to function setjmp, and thus the setjmp block of instructions, is not instrumented. Consequently, there is only one continued location for function setjmp( ), which is in the original code. Regardless of whether function longjmp( ) or function longjmp′( ) is executed, execution reaches this setjmp-continued location and executes the corresponding setjmp block of instructions.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows an exemplary text segment of a program, in accordance with one embodiment;

FIG. 2 shows an example of how functions setjmp( ) and longjmp( ) are invoked, in accordance with one embodiment;

FIG. 3 shows instrumented code of the program in FIG. 1, in accordance with one embodiment;

FIG. 4 shows an example of how instrumented functions setjmp′( ) and longjmp′( ) are invoked, in accordance with one embodiment; and

FIG. 5 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### The Original Code

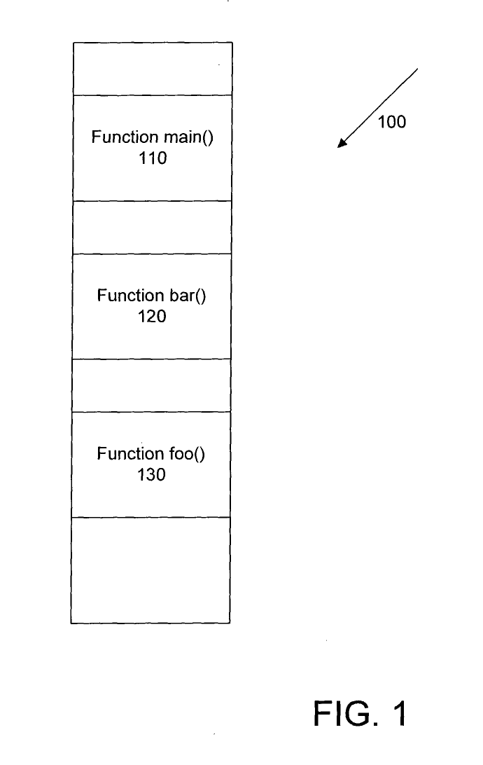

FIG. 1 shows a text segment 100 that is part of a program, e.g., program progA (not shown), in accordance with one embodiment using the C language. Segment 100, includes a section 110, a section 120, and a section 130, which correspond to a function main( ), a function bar( ), and a function foo( ), respectively. Function main( ) is the main function of program progA while function bar( ) and function foo( ) are normal functions. A function refers to a section of programming code callable by other code and encompasses subroutines in the Fortran language, procedures in the Pascal language, methods in the C++ or Java language, and other similar constructs in the programming art. In general, a function includes a set of instructions beginning at an entry point and ending at an endpoint. When a function is called, execution begins at the entry point. At the endpoint, execution control is normally returned to the instruction following the function call. However, in bundled-instruction situations such as in Very Large Instruction Word (VLIW) architectures, instructions are grouped together in bundles, and each bundle, instead of individual instructions, is executed at a time. In such architectures, execution may return to the next bundle. Nevertheless, techniques of the invention are applicable regardless of the position of the return location.

For illustration purposes, function main( ) includes a call to function setjmp( ) and a call to function bar( ); function bar( ) includes a call to function foo( ); and function foo( ) includes a call to function longjmp( ). The pair of functions setjmp( ) and longjmp( ) may be known variably as the pair _setjmp( ) and _longjmp( ), the pair sigsetjmp( ) and siglongjmp( ), etc.

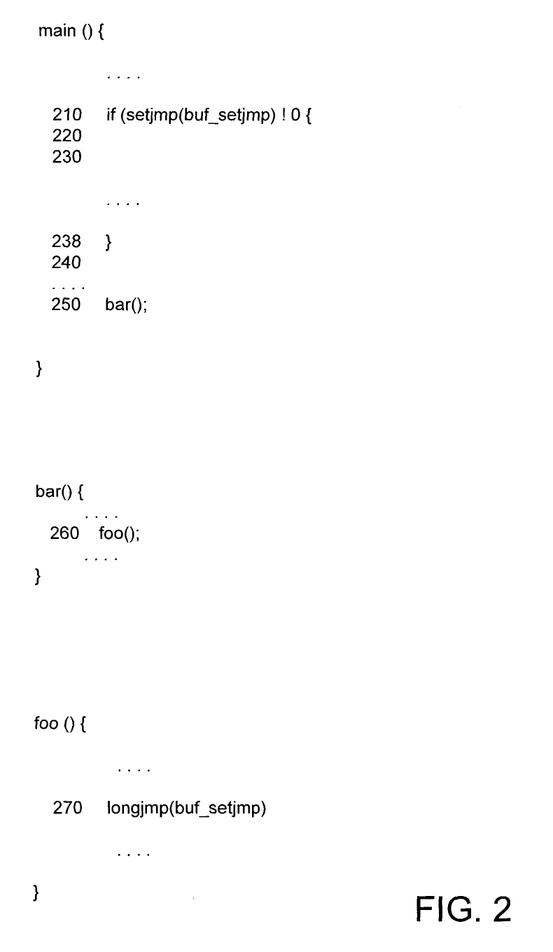

FIG. 2 is used to illustrate how function main( ), function bar( ), function foo( ), function setjump( ), and function longjmp( ) are called, in accordance with one embodiment. Without the pair of functions setjmp( ) and longjmp( ), the setjmp( ) block of instructions, i.e., the block covered by the set of bracket ‘{’ and ‘}’ on lines 210 and 238, does not exist. Execution of program progA starts with function main( ), to the instruction on line 240, to function bar( ) on line 250, and to function foo( ) on line 260, etc. Execution then returns from function foo( ), function bar( ), and function main( ) at appropriate entry points and endpoints of these functions.

However, for various reasons such as to handle errors and/or interrupts, functions setjmp( ) with the setjmp( ) block of instructions and function longjmp( ) are added, but the conventional execution control at entry points and endpoints is not observed. Execution starts with function main( ), executing the if statement on line 210 that makes a call to function setjmp( ) and that generally returns a logical false value based on which execution skips the setjmp block of instructions between lines 220 and 238. Execution then continues with the instruction on line 240, function bar( ) on line 250, function foo( ) on line 260, function longjmp( ) on line 270, etc. However, the call to function setjmp( ) on line 210 sets values in buffer buf_setjmp so that, after function longjmp( ) is executed, the setjmp( ) block of instructions, based on the information passed to buffer buf_setjmp, is executed starting with an instruction on line 220, as if the “if” statement on line 210 had returned a logical true. For illustration purpose, the location of the instruction on line 220 is referred to as the setjmp-continued location. Further, for the pair of functions setjmp( ) and longjmp( ), the setjmp-continued location is immediately after the call to function setjmp( ). For other groups and/or pair of related functions, the setjmp-continued location varies, but is relative to the call to function setjmp( ), and techniques of the invention are also applicable to those situations.

Buffer buf setjmp used by function setjmp( ) on line 210 and function longjmp( ) on line 270 stores information needed for function longjmp( ) to restore the context of program progA as if execution were at the point where function setjmp( ) on line 210 was executed. Information stored in buffer buf_setjmp is accumulated during execution of program progA and includes, for example, the instruction pointer, the stack pointer, the return pointer, the values of local variables of function main( ), function bar( ), function foo( ), etc. This information also includes the setjmp-continued location on line 220, which, in effect, is recorded in memory through function setjmp( ).

The order of function invocation from function main( ), to function bar( ), and to function foo( ), which includes a call to function longjmp( ), is used only as an example. Techniques of the invention may be used in any order that function lonjump( ) may be invoked by other programming code or functions. For example, a call to function longjmp( ) may be part of function foo( ) as in the above example, and function foo( ) thus directly invokes function longjmp( ). Similarly, function main( ) may invoke function foo( ) through one or a plurality of other functions such as function bar( ). Alternatively, function main( ) may include a call to function longjmp( ) and thus invokes it directly.

### The Instrumented Code

During dynamic instrumentation of program progA and its functions, the instrumentation tools typically add probe code to the original code of these functions to form and also execute the instrumented code.

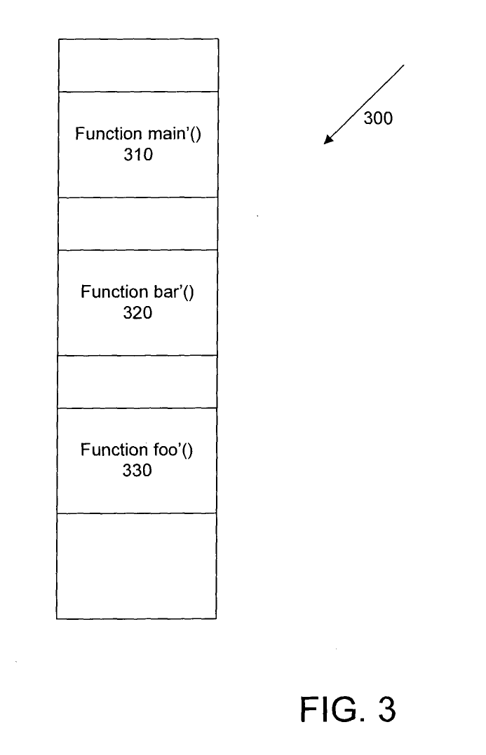

FIG. 3 shows instrumented code 300 of program progA, which includes instrumented code 310, 320, and 330 of function main′( ), function bar′( ), and function foo′( ), respectively. Code 310, 320, and 330 correspond to the text segments 110, 120, and 130 of the original code of function main( ), function bar( ), and function foo( ), respectively. Code 300 including function main′( ), function bar′( ), and function foo′( ) is typically stored in shared memory. Function main′( ) includes a call to function setjmp′( ), and function foo′( ) includes a call to function longjmp′( ) wherein function setjmp′( ) and function longjmp′( ) are the instrumented versions of function setjmp( ) and function longjmp( ), respectively. Instrumented functions setjmp′( ) and longjmp′( ) are used as an example, embodiments of the invention are also applicable in situations in which function setjmp( ) and/or function longjmp( ) are not instrumented. In such situations, a call to function setjmp′( ) on line 410 is in fact a call to function setjmp( ). Similarly, a call to function longjmp′( ) on line 470 is in fact a call to function longjmp( ).

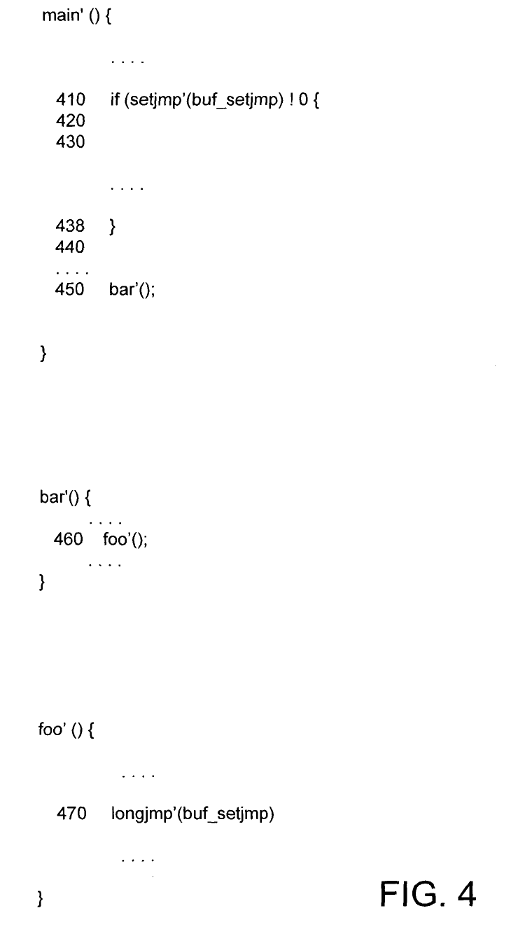

FIG. 4 is used to illustrate how function main′( ), function bar′( ), function foo′( ), function setjmp′( ), and function longjmp′( ) are invoked, in accordance with one embodiment. When function main( ) is invoked, the instrumentation tool initializes the dynamic instrumentation and accordingly generates functions main′( ), function bar′( ), function foo′( ), function setjmp′( ), and function longjmp′( ), etc. Similar to execution of function main( ), execution starts with function main′( ), executing the if statement on line 410 that makes a call to function setjmp′( ) and that generally returns a logical false value based on which execution skips the setjmp′ block of instructions between lines 420 and 438. Execution then continues with the instruction on line 440, function bar′( ) on line 450, function foo′( ) on line 460, function longjmp′( ) on line 470, etc. However, the call to function setjmp′( ) on line 410 also sets values in buffer buf_setjmp so that once function longjmp′( ) on line 470 is executed, execution, based on the information stored in buffer buf_setjmp, continues with an instruction on line 420.

Buffer buf_setjmp used by function setjmp′( ) on line 410 and function longjmp′( ) on line 470 stores information needed for function longjmp′( ) to restore the machine context of the instrumented program progA as if execution were at the point where function setjmp′( ) on line 410 was executed.

### Un-Instrumentation

Un-instrumentation refers to discarding the instrumented code and reverting to execution of the original code of a program. In general, a piece of code in the instrumented code corresponds to a piece of code in the original code. In one embodiment, the instrumentation tool includes information to map code between the original code and instrumented code. When un-instrumentation occurs, the original code is restored and execution continues with the instruction in the original code that corresponds to the instruction in the instrumented code that would have been executed if un-instrumentation did not occur. In one embodiment, invoking function fork( ) in a program causes un-instrumentation of the program, and the instrumentation tool takes the necessary steps to discard the instrumented code, to clean up the call stack and the text segment, to restore to the original code and context, etc. Embodiments of the invention provide techniques for functions setjmp( ) and longjmp( ) to work effectively with both instrumentation and un-instrumentation.

### Intercepting a Function

Intercepting a function may be done in various ways. In one embodiment, intercepting includes the step of setting a breakpoint immediately after the entry point of that function, which causes execution control to be transferred to the instrumentation tool when the function is invoked. At the breakpoint, information and/or data related to that function may be controlled, e.g., observed, modified, stored, saved for later use, etc.

### THE FIRST EMBODIMENT

In one embodiment of performing instrumentation on program progA, when the entry point of function main( ) is reached, execution control is transferred to the instrumentation tool, which initializes instrumentation, and creates function main′( ) and other instrumented functions as appropriate. Execution is transferred to function main′( ), which is then allowed to be executed normally. When the call to function setjmp′( ) on line 410 is reached, but before function setjmp′( ) is executed, function setjmp′( ) is intercepted, buffer buf_setjmp, its location, its content that includes the setjmp-continued location at line 420, and information related to this setjmp-continued location are saved for later use. Execution then continues to line 440, line 450, line 460, line 470, etc. In accordance with operations of functions setjmp′( ) and longjmp′( ), when function longjmp′( ) is invoked and based on the information in buffer buf_setjmp, execution control is transferred to the instruction at the setjmp′-continued location on line 420.

However, when un-instrumentation occurs and based on the saved location 420, location 220 in the original code corresponding to location 420 in the instrumented code is identified and stored in buffer buf_setjmp. The instrumented code that includes function main′( ), function foo′( ), function setjmp′( ), function longjmp′( ), etc., is discarded. Execution reverts to the original code at a location corresponding to the location in the instrumented code that would have been executed if un-instrumentation did not occur. Execution then continues until function longjmp( ) on line 270 is executed, which, based on the information stored in buffer buf_setjmp, causes execution to continue at location 220. Consequently, instructions in the setjmp( ) block from lines 220 to 238 are executed.

### THE SECOND EMBODIMENT

In this embodiment, a breakpoint, e.g., breakpoint BK, is set at line 220. If instrumentation occurs without un-instrumentation, then this breakpoint BK still exists when execution reaches lines 220. However, if un-instrumentation occurs after instrumentation, then the un-instrumentation process, while restoring to the original code, clears this breakpoint BK, and execution does not encounter breakpoint BK when execution reaches line 220.

When the entry point of function main( ) is reached, execution control is transferred to the instrumentation tool, which initializes instrumentation, and creates function main′( ) and other instrumented functions as appropriate. Execution is transferred to function main′( ), which is then allowed to be executed normally. When function setjmp′( ) is reached, but before being executed, function setjmp′( ) is intercepted, and execution control is transferred to the instrumentation tool. At this time, buffer buf_setjmp contains the continued location as line 420, but it is changed to 220. Execution then continues to line 440, line 450, etc.

If un-instrumentation has not occurred, execution will reach and execute function longjmp′( ) on line 470. Based on the change to location 220 in buffer buf_setjmp as discussed above, after function longjmp′( ) is executed, execution reaches line 220. Because un-instrumentation has not occurred, execution encounters breakpoint BK, and is therefore directed to line 420 by the controlling instrumentation tool, for execution to continue from that line with the instrumented code. In one embodiment, a branch instruction is use to branch to line 420.

However, if un-instrumentation has occurred, then the instrumented code is discarded, and program execution reverts to the original code in FIG. 2. Execution then continues until function longjmp( ) on line 270 is executed, which, based on the change to location 220 as discussed above, also causes execution to reach line 220. Because un-instrumentation has occurred, the original code has been restored, and breakpoint BK has been cleared. Execution therefore does not encounter breakpoint BK, starts at line 220, and continues with instructions on line 230, etc., to line 238.

Breakpoint BK is used in one embodiment, but other instructions may be used in place of breakpoint BK and yet utilize techniques of the invention. For example, a branch instruction replaces breakpoint BK, and thus automatically directs execution to line 420 when this branch instruction is reached.

### THE THIRD EMBODIMENT

In this embodiment, the function that includes a call to function setjmp( ), and thus the setjmp block of instructions, is not instrumented. In the example of FIG. 2, when the entry point of function main( ) is reached, execution control is transferred to the instrumentation tool, which analyzes function main( ), and, because function main( ) includes a call to function setjmp( ), function main( ) is not instrumented, i.e., function main′( ) is not created. Execution is transferred back to function main( ), which is then allowed to be executed normally, and subsequently-called functions will get instrumented according to the regular operation of the controlling instrumentation tool. Because function main( ) is not instrumented, there is not function main′( ), not the setjmp′ block of instruction between lines 420 and 438, not the setjmp′-continued location at line 420, etc. However, there still exists the setjmp-continued location at line 220. As a result, regardless of whether function longjmp( ) on line 270 or function longjmp′( ) on line 470 is executed, execution continues at the setjmp-continued location at line 220, and thus executes the setjmp block of instructions between lines 220 and 238.

Because, in the FIG. 2 example, function main( ) includes a call to function setjmp( ), function main( ) is not instrumented. However, if function main( ) includes a call to, for example, function wrapper( ), and function wrapper( ) includes a call to function setjmp( ), then function main( ) can still instrumented, but function wrapper( ) is not instrumented. Similarly, if function wrapper( ) includes a call to function wrapper1( ); function wrapper1( ) includes a call to function wrapper2( ), and function wrapper2( ) includes a call to function setjmp( ), etc., then functions wrapper( ) and wrapper1( ) can still be instrumented while function wrapper2( ) is not instrumented, etc.

### Computer System Overview

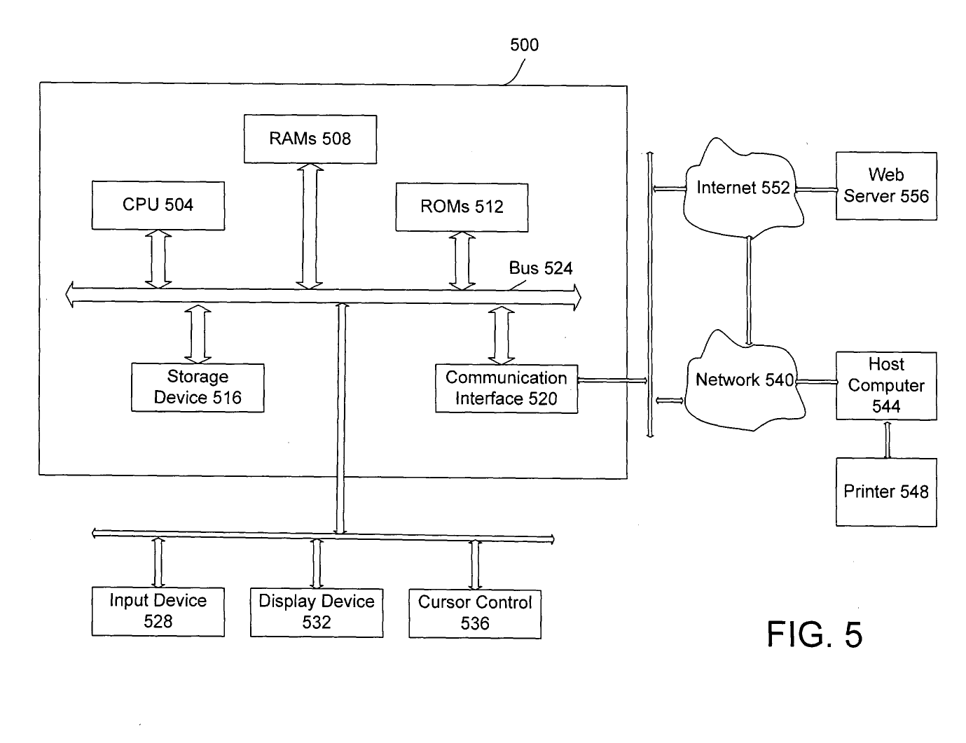

FIG. 5 is a block diagram showing a computer system 500 upon which an embodiment of the invention may be implemented. For example, computer system 500 may be implemented to run program progA, the instrumentation tool, to perform functions in accordance with the techniques described above, etc. In one embodiment, computer system 500 includes a central processing unit (CPU) 504, random access memories (RAMs) 508, read-only memories (ROMs) 512, a storage device 516, and a communication interface 520, all of which are connected to a bus 524.

CPU 504 controls logic, processes information, and coordinates activities within computer system 500. In one embodiment, CPU 504 executes instructions stored in RAMs 508 and ROMs 512, by, for example, coordinating the movement of data from input device 528 to display device 532. CPU 504 may include one or a plurality of processors.

RAMs 508, usually being referred to as main memory, temporarily store information and instructions to be executed by CPU 504. Information in RAMs 508 may be obtained from input device 528 or generated by CPU 504 as part of the algorithmic processes required by the instructions that are executed by CPU 504.

ROMs 512 store information and instructions that, once written in a ROM chip, are read-only and are not modified or removed. In one embodiment, ROMs 512 store commands for configurations and initial operations of computer system 500.

Storage device 516, such as floppy disks, disk drives, or tape drives, durably stores information for use by computer system 500.

Communication interface 520 enables computer system 500 to interface with other computers or devices. Communication interface 520 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 520 may also allow wireless communications.

Bus 524 can be any communication mechanism for communicating information for use by computer system 500. In the example of FIG. 5, bus 524 is a media for transferring data between CPU 504, RAMs 508, ROMs 512, storage device 516, communication interface 520, etc.

Computer system 500 is typically coupled to an input device 528, a display device 532, and a cursor control 536. Input device 528, such as a keyboard including alphanumeric and other keys, communicates information and commands to CPU 504. Display device 532, such as a cathode ray tube (CRT), displays information to users of computer system 500. Cursor control 536, such as a mouse, a trackball, or cursor direction keys, communicates direction information and commands to CPU 504 and controls cursor movement on display device 532.

Computer system 500 may communicate with other computers or devices through one or more networks. For example, computer system 500, using communication interface 520, communicates through a network 540 to another computer 544 connected to a printer 548, or through the world wide web 552 to a server 556. The world wide web 552 is commonly referred to as the “Internet.” Alternatively, computer system 500 may access the Internet 552 via network 540.

Computer system 500 may be used to implement the techniques described above. In various embodiments, CPU 504 performs the steps of the techniques by executing instructions brought to RAMs 508. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 504 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 504 are in the form of one or more software programs and are initially stored in a CD-ROM being interfaced with computer system 500 via bus 524. Computer system 500 loads these instructions in RAMs 508, executes some instructions, and sends some instructions via communication interface 520, a modem, and a telephone line to a network, e.g. network 540, the Internet 552, etc. A remote computer, receiving data through a network cable, executes the received instructions and sends the data to computer system 500 to be stored in storage device 516.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for running a program in conjunction with instrumentation, comprising the steps of:
providing a first call to a first function and a first call to a second function; wherein executing the second function causes execution to continue at a first location relative to the location of the first call to the first function;
upon instrumentation of the program, providing a second call to the first function and a second call to the second function; wherein executing the second function by the second call to the function causes execution to continue at a second location relative to the location of the second call to the first function, and the second location corresponds to the first location;
upon reaching the second call to the first function, identifying the second location;
from the second location, identifying the first location; and
after un-instrumentation of the program and upon execution of the second function by the first call to function, causing execution to continue at the identified first location.

2. The method of claim 1 wherein the second call to the first function invokes an instrumented version of the first function.

3. The method of claim 1 wherein the second call to the second function invokes an instrumented version of the second function.

4. The method of claim 1 wherein upon reaching the second call to the first function further comprises the steps of setting a breakpoint at the beginning of the first function, and causing execution control to be transferred to an instrumentation tool.

5. The method of claim 1, after identifying the first location, storing information related to the first location in a buffer used by the first and the second function

6. A method for running a program in conjunction with instrumentation, comprising the steps of:
providing a first call to a first function and a first call to a second function; wherein executing the second function causes execution to continue at a first location relative to the location of the first call to the first function;
upon instrumentation of the program, providing a second call to the first function and a second call to the second function; wherein executing the second function by the second call to the second function causes execution to continue at a second location relative to the second call to the first function;
providing an instruction at the first location; wherein the instruction is removed upon un-instrumentation of the program; and
after executing the second function by either the first call or the second call to the second function, allowing execution to continue at the first location.

7. The method of claim 6, after executing the second function by the second call to the second function and upon encountering the instruction provided at the first location, further comprising the step of continuing execution at the second location.

8. The method of claim 6, after executing the second function by the first call to the second function and reaching the first location without encountering the instruction provided at the first location, further comprising the step of executing an instruction following the instruction provided at the first location.

9. The method of claim 6 wherein the step of allowing execution to continue at the first location comprising the step of changing the content of a buffer associated with the first function to include information related to the first location.

10. The method of claim 6 wherein the second call to the first function invokes an instrumented version of the first function.

11. The method of claim 6 wherein the second call to the second function invokes an instrumented version of the second function.

12. The method of claim 6 wherein executing the second function by the first call to the second function is after un-instrumentation of the program.

13. A method for running a program in conjunction with instrumentation, comprising the steps of:
providing a first call to a first function and a first call to a second function; wherein executing the second function causes execution to continue at a first location relative to the location of the first call to the first function;
upon instrumentation of the program, providing a second call to the second function; and
causing execution to continue at the first location upon executing the second function by either the first call or the second call to the second function; wherein executing the second function by the first call is after un-instrumentation of the program.

14. The method of claim 13 wherein the second call to the second function invokes an instrumented version of the function.

15. The method of claim 13, upon instrumentation of the program, further comprising the step of deciding not to instrument a function that includes the second call to the first function.

16. A computer-readable medium embodying instructions for a computer to perform a method for running a program in conjunction with instrumentation, the method comprising the steps of:
providing a first call to a first function and a first call to a second function; wherein executing the second function causes execution to continue at a first location relative to the location of the first call to the first function;
upon instrumentation of the program, providing a second call to the first function and a second call to the second function; wherein executing the second function by the second call to the function causes execution to continue at a second location relative to the location of the second call to the first function, and the second location corresponds to the first location;
upon reaching the second call to the first function, identifying the second location;
from the second location, identifying the first location; and
after un-instrumentation of the program and upon execution of the second function by the first call to function, causing execution to continue at the identified first location.

17. The computer-readable medium of claim 16 wherein the second call to the first function invokes an instrumented version of the first function.

18. The computer-readable medium of claim 16 wherein the second call to the second function invokes an instrumented version of the second function.

19. The computer-readable medium of claim 16 wherein upon reaching the second call to the first function further comprises the steps of setting a breakpoint at the beginning of the first function, and causing execution control to be transferred to an instrumentation tool.

20. The computer-readable medium of claim 16, after identifying the first location, storing information related to the first location in a buffer used by the first and the second function

21. A computer-readable medium embodying instructions for a computer to perform a method for running a program in conjunction with instrumentation, the method comprising the steps of:
providing a first call to a first function and a first call to a second function; wherein executing the second function causes execution to continue at a first location relative to the location of the first call to the first function;
upon instrumentation of the program, providing a second call to the first function and a second call to the second function; wherein executing the second function by the second call to the second function causes execution to continue at a second location relative to the second call to the first function;
providing an instruction at the first location; wherein the instruction is removed upon un-instrumentation of the program; and
after executing the second function by either the first call or the second call to the second function, allowing execution to continue at the first location.

22. The computer-readable medium of claim 21, after executing the second function by the second call to the second function and upon encountering the instruction provided at the first location, further comprising the step of continuing execution at the second location.

23. The computer-readable medium of claim 21, after executing the second function by the first call to the second function and reaching the first location without encountering the instruction provided at the first location, further comprising the step of executing an instruction following the instruction provided at the first location.

24. The computer-readable medium of claim 21 wherein the step of allowing execution to continue at the first location comprising the step of changing the content of a buffer associated with the first function to include information related to the first location.

25. The computer-readable medium of claim 21 wherein the second call to the first function invokes an instrumented version of the first function.

26. The computer-readable medium of claim 21 wherein the second call to the second function invokes an instrumented version of the second function.

27. The computer-readable medium of claim 21 wherein executing the second function by the first call to the second function is after un-instrumentation of the program.

28. A computer-readable medium embodying instructions for a computer to perform a method for running a program in conjunction with instrumentation, the method comprising the steps of:
providing a first call to a first function and a first call to a second function; wherein executing the second function causes execution to continue at a first location relative to the location of the first call to the first function;
upon instrumentation of the program, providing a second call to the second function; and
causing execution to continue at the first location upon executing the second function by either the first call or the second call to the second function; wherein executing the second function by the first call is after un-instrumentation of the program.

29. The computer-readable medium of claim 28 wherein the second call to the second function invokes an instrumented version of the function.

30. The computer-readable medium of claim 28, upon instrumentation of the program, further comprising the step of deciding not to instrument a function that includes the second call to the first function.
